(19) United States
(12) Patent Application Publication
(10) Pub. No.: US 2008/0077782 A1
(43) Pub. Date: Mar. 27, 2008

(54) Restoring a register renaming table within a processor following an exception

(75) Inventors: Norbert Bernard Eugene Lataille, Le Cannet (FR); Florent Begon, Antibes (FR); Cedric Denis Robert Airaud, Saint Laurent Due Var (FR); Melanie Vincent, Grasse (FR)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/526,870

(22) Filed: Sep. 26, 2006

(51) Int. Cl. G06F 7/38

(52) U.S. Cl. 712/244

(57) ABSTRACT

Control logic for storing values relating to unresolved exception instructions within a buffer to enable a register renaming table within a processor to be restored following an exception is disclosed. The processor is operable to process a stream of instructions from an instruction set, the instruction set comprising exception instructions and non-exception instructions, exception instructions being instructions that may generate an exception and non-exception instructions being instructions that execute in a statically determinable way. The processor comprises a physical set of registers operable to store data values being processed by the processor; and register renaming logic operable to receive a stream of decoded instructions and to map for each decoded instruction within the stream of decoded instructions, registers from an architectural set of registers associated with the instruction set to registers within the physical set of registers in dependence upon renaming values stored in the register renaming table; the control logic comprising a buffer and being operable: to identify exception and non-exception instructions within the decoded instruction stream and to group any non-exception instructions with a closest preceding exception instruction; to store in the buffer, register renaming values relating to any registers whose data values are modified by the group of instructions and which are renamed by the register renaming logic as a bundle of register renaming values associated with the exception instruction.

### BACKGROUND OF THE INVENTION

1. Field of the Invention

The field of the invention relates to data processing and in particular to register renaming in a CPU.

2. Description of the Prior Art

It is known to provide processors which process instructions from an instruction set specifying an architectural set of registers using a physical set of registers that is larger than the architectural set. This is a technique that has been developed to try to avoid resource conflicts due to instructions executing out of order in the processor. In order to have compact instruction encodings most processor instruction sets have a small set of register locations that can be directly named. These are often referred to as the architecture registers and in many ARM® (registered trade mark of ARM Ltd Cambridge UK) RISC instruction sets there will be 32 architecture registers.

When instructions are processed different instructions take different amounts of time. In order to speed up execution times, processors may have multiple execution units, or may perform out of order execution. This can cause problems if the data used by these instructions is stored in a very limited register set as a value stored in one register may be overwritten before it is used by another instruction. This leads to errors. In order to address this problem it is know for some processing cores to perform processing using more registers than are specified in the instruction set. Thus, for example, a core may have 56 physical registers to process an instruction set having 32 architecture registers. This enables a core to store values in more registers than is specified by the instruction set and can enable a value needed by an instruction that takes a long time to be executed to be stored in a register not used by other neighbouring instructions. In order to be able to do this the core needs to “rename” the registers referred to in the instruction so that they refer to the physical registers in the core. In other words an architectural register referred to in the instruction is remapped onto a physical register that is actually present on the core. Details of known ways of doing this can be found in “register renaming—Wikipedia” at http://en.wikipedia.org/wiki/Register_renaming.

Renaming of the registers is generally done using a renaming table which maps registers from the architecture set of registers to registers in the physical set for a particular instruction. As the remapping is dependent on the decoded instruction being executed and the renaming occurs early in the processing a problem can arise if an exception occurs during processing of the decoded instruction. In some processors the renaming table is referred to as the future table as it remaps decoded instructions that are yet to be processed. Thus, a register renaming core has to take special care when speculating over potential exception points such as branch instructions or memory access instructions, as if processing of the instruction creates an exception the remapping information for that decoded instruction and for subsequent decoded instructions is no longer available. In the case of such an exception or misprediction the core has to be able to recover the architectural state of its register bank.

This problem has been addressed in a number of ways in the prior art. In some cases register bank checkpoints are used and the register renaming or mapping tables are duplicated whenever an unresolved exception instruction is encountered. When the processed exception instruction is, resolved as not creating an exception then the duplicated renaming table for that instruction (checkpoint) can be deleted. If the processed instruction creates an exception then the decoded instruction can be replayed as the appropriate renaming table has been stored. This duplication of register renaming table is very expensive in storage space.

It would be desirable to be able to decrease the storage requirements for restoring a renaming table following an exception.

### SUMMARY OF THE INVENTION

A first aspect of the present invention provides control logic for storing values relating to unresolved exception instructions within a buffer to enable a register renaming table within a processor to be restored following an exception; said processor being operable to process a stream of instructions from an instruction set, said instruction set comprising exception instructions and non-exception instructions, exception instructions being instructions that may generate an exception and non-exception instructions being instructions that execute in a statically determinable way, said processor comprising a physical set of registers operable to store data values being processed by said processor; and register renaming logic operable to receive a stream of decoded instructions and to map for each decoded instruction within said stream of decoded instructions, registers from an architectural set of registers associated with said instruction set to registers within said physical set of registers in dependence upon renaming values stored in said register renaming table; said control logic comprising a buffer and being operable: to identify exception and non-exception instructions within said decoded instruction stream and to group any non-exception instructions with a closest preceding exception instruction; to store in said buffer, register renaming values relating to any registers whose data values are modified by said group of instructions and which are renamed by said register renaming logic as a bundle of register renaming values associated with said exception instruction.

The present invention recognises that many RISC processors comprise a high number of exception points which leads to very few registers being updated between two exception points. It also recognises that in order to restore the register renaming table following an exception there is no need to have a precise instruction view in the pipeline it is sufficient to have an exception point based structure and to simply store data relating to the registers which are renamed or remapped between the two exception points. Thus, the present invention identifies “exception” and “non-exception” instructions within a decoded instruction stream and groups together the non-exception instructions with a previous exception instruction. In other words, it locates exception points relating to exception instructions within the decoded instruction stream and groups the decoded instructions together around these points. It then stores in a buffer the appropriate register renaming values relating to registers whose data values are modified by this group of decoded instructions and it does this as a bundle of register renaming values. Thus, a very small amount of information is stored but it is sufficient to update the register renaming table following an exception.

In some embodiments, said control logic is further operable to receive information relating to said exception instructions and indicative of whether said exception instructions are resolved such that they are assured to execute and not generate an exception; and in response to receiving information that an exception instruction is resolved to update a restore table within said processor with said register renaming values associated with said resolved exception instruction stored in said buffer; and to flush said data associated with said resolved exception instruction from said buffer; said restore table comprising renaming values for mapping registers from said architectural set to said physical set for a previously resolved exception instruction.

One advantage of embodiments of the present invention is that information that is saved can be used to simply update a restore table, the restore table being in effect the register renaming table at the last resolved exception. Thus, every time an exception instruction is resolved it is updated with the necessary remapping of the registers. Thus, when an exception occurs it is a very simple matter to update the register renaming table by overwriting it with the restore table. In fact, this can be done in a single clock cycle.

The buffer wherein this data is stored can take a number of forms, but in some embodiments it comprises a FIFO buffer. That is a first in first out buffer. A FIFO buffer is particularly advantageous to store this data as it is simple to control. Provided the exception instructions are dealt with in order no additional control of the FIFO is needed and thus, a simple structure and simple control logic can be used.

It will be appreciated, that exception instructions can comprise a number of things including memory access instructions and branch instructions.

Memory access control instructions may cause exceptions where, for example they try to access memory in a secure part of the processor for which they do not have sufficient privilege. Branch instructions can cause exceptions where they are mispredicted.

In some embodiments, said control logic further comprises a counter, operable to count a number of exception instructions identified, said counter value being stored as instruction identifier data within said buffer along with said register renaming values associated with said identified exception instruction, said control logic being operable to amend said counter value and said instruction identifier data in response to receipt of information that an exception instruction is resolved, such that said counter value indicates a number of unresolved exception instructions identified.

A particularly advantageous way of storing the register renaming values is to store them alongside a counter value indicating a number of exception instructions identified that have not yet been resolved. If a counter is used, it is a simple matter to determine when the exception instruction associated with the stored value has been resolved. The counter can obviously take a number of forms and can increment or be decremented. Generally, when an exception instruction is identified and the data is added to the table the counter value is increased and the value in that counter is stored as the instruction identifier along with the data. When an exception instruction is resolved the counter is decremented, as are all the instruction identifiers stored in the table. If the system is done in this way, when an instruction identifier relating to the stored data reaches zero then this indicates that the exception instruction associated with that data has been resolved.

In some embodiments, said control logic is operable to identify a group of instructions where no registers have; data values that are modified by said group of instructions and no registers associated with said group of instructions are renamed by said register renaming logic, and to count said exception instruction from said group of instructions with said counter and not to store any data relating to said identified exception instruction in said buffer, said control logic being operable to amend said counter value in response to information that said identified exception instruction has been resolved.

It is a particularly advantageous feature of embodiments of this invention, that if a group of instructions associated with an exception instruction are found not to modify data in any registers, then these registers will not have been renamed by the renaming logic and there is no need to store any information relating to them in the buffer. The use of a counter enables no information to be stored relating to these instructions, the counter is simply updated when the exception instruction is identified and updated again in the other direction when it is resolved. As the counter has been incremented in response to this instruction there will be no instruction identifier reaching the predetermined value, for example zero when it is decremented and thus it will be clear to the control logic that although the instruction has been resolved no operation needs to be performed on the buffer as no data is stored in it relating to this instruction.

In some embodiments, said control logic is operable in response to said instruction identifier data indicating no unresolved exception instructions before said exception instruction in said instruction stream to update said restore table with said register renaming values associated with said instruction identifier data and then to flush said associated register renaming values and said instruction identifier data from said buffer.

The use of an instruction identifier such as a counter indicating when an exception instruction has been resolved, enables the control logic to know that the data relating to that instruction can be flushed from the buffer and stored in the restore table.

In some embodiments, said control logic is operable to store said register renaming values in a row in said buffer along with said instruction identifier data, and if said register renaming values will not fit in said row to store said remaining values in subsequent rows along with said instruction identifier data.

By identifying exception instructions in a simple way and storing the register renaming values in association with this identifier, register renaming values can be merged together within a single line in a buffer and if there are too many then a further line(s) can be used provided the same instruction identifier is used to identify this line.

In some embodiments, said control logic is operable when updating said restore table to retrieve any renaming values that are to be overwritten and to output data from said retrieved renaming values relating to the physical register renamed.

One advantageous feature of embodiments of the present invention is that once a physical register is evicted from the restore table it is clear that it is no longer storing a value that might be used by a subsequent instruction and this register can then be used to store other data, i.e. an architectural register can be mapped to it. Determining when a register is free to be used again is a particular problem of register renaming. The storage of register renaming information in a buffer and restore table enables the information to be available in a simple manner.

In some embodiments, said control logic is operable when updating said restore table to retrieve any renaming values that are to be overwritten and to output data relating to a physical register that has been overwritten to said register renaming logic, said register renaming logic being operable to determine a free list of physical registers available to be allocated from said received data.

One advantageous feature of embodiments of the present invention is that once a physical register is evicted from the restore table it is clear that it is no longer storing a value that might be used by a subsequent instruction and this register can then be added to the free list. Determining when a register is free to be used again is a particular problem of register renaming. The storage of register renaming information in a buffer and restore table enables the information to be available in a simple manner.

In some embodiments, said control logic is operable to identify said exception instructions as branch exception instructions and memory access exception instructions, said control logic comprising two counters, a branch counter operable to count a number of identified branch exception instruction, and a load counter operable to count a number of identified memory access exception instructions, said values of said two counters being stored as instruction identifier data within said buffer along with said register renaming values relating to said identified exception instruction, said control logic being operable to amend said corresponding counter and said corresponding portion of said instruction identifier data in response to receipt of information that a branch or memory access exception instruction is resolved, such that said respective counter values indicate a number of unresolved exception instructions of a particular type identified.

It may be preferable to identify what type of exception instructions are to be processed and to use an exception instruction identifier that identifies not only the number of exception instructions but also the number of a particular type. This can be very helpful where different exception instruction handling units are provided by the processor. For example, there may be a branch prediction unit for handling branch predictions and a load store unit for handling memory access instructions. As these are different units, information regarding whether an exception is resolved or not will come from each unit in the order of decoded instructions that it looks at, but information from decoded instructions from one unit may be received before information relating to a previous decoded instruction in the instruction stream which is handled by the other unit. For example, the branch prediction unit may provide information regarding the resolution of a branch exception instruction which occurred in an instruction stream before a load exception instruction after the load store unit provides this information. This could cause problems if a single counter were used as control logic, as this would assume that it was the oldest instruction in the buffer that had been resolved whereas in fact it was the oldest load instruction that had been resolved. In order to stop this occurring two counters can be used and it is only when the two counters reach a predetermined value for a particular instruction that it is known that these instructions are resolved.

In some embodiments, said control logic is operable in response to receiving information that processing of an exception instruction has generated an exception, to flush said buffer and to forward said restore table to said processor for overwriting said register renaming table.

When an exception occurs, then the state of the processor at this point needs to be restored. Thus, the register renaming table is updated with information from the restore table which holds the register renaming values at the previous resolved exception instruction and the buffer can be flushed. The program counter is then set to point to the instruction that needs to be executed after the exception.

A further aspect of the present invention provides a data processing apparatus operable to process a stream of instructions from an instruction set, said instruction set comprising exception instructions and non-exception instructions, exception instructions being instructions that may generate an exception and non-exception instructions being instructions that execute in a statically determinable way, said processor comprising: control logic according to a first aspect of the present invention; an instruction decoder operable to receive and decode said stream of instructions; a physical set of registers operable to store data values being processed by said data processing apparatus; a data store operable to store a register renaming table comprising values that map each register of said architectural set to a register in said physical set for a decoded instruction; register renaming logic operable to receive said stream of decoded instructions, and to populate said register renaming table with values appropriate for said received decoded instructions, said register renaming logic being operable to remap any registers associated with said received decoded instructions in dependence upon said values within said renaming table; a further data store operable to store a recover table, said recover table comprising values from said remapping table for a previous instruction in said sequence of received decoded instructions, said previous instruction being a resolved exception instruction, a resolved exception instruction being an instruction that could have generated an exception but has been resolved not to.

In some embodiments said data processing apparatus comprises at least one exception instruction handling unit operable to determine whether processing of an exception instruction will generate an exception or whether it is resolved not to and operable to provide said information to said control logic

An exception instruction handling unit determines whether an instruction will create an exception or not. If it is resolved that it will not then this information is sent back to the control logic which then flushes the data from the buffer and stores it in the restore table. Once an exception instruction is resolved then the renaming data associated with it need no longer be stored in the buffer. It is still stored by the data processing apparatus in a restore table until another exception instruction is resolved. The restore table holds the renaming data of the last resolved instruction as it is this data that is needed to restore the renaming table following an exception.

A yet further aspect of the present invention provides a method for storing values relating to unresolved exception instructions within a buffer to enable a register renaming table within a processor to be restored following an exception, the processor being operable to process a stream of instructions from an instruction set, the instruction set comprising exception instructions and non-exception instructions, exception instructions being instructions that may generate an exception and non-exception instructions being instructions that execute in a statically determinable way, the processor comprising a physical set of registers operable to store data values being processed by the processor; and register renaming logic operable to map for each decoded instruction, registers from an architectural set of registers associated with the instruction set to registers within said physical set of registers in dependence upon renaming values stored in said register renaming table; said method comprising the following steps: identifying exception and non-exception instructions within a decoded instruction stream; grouping any non-exception instructions with a closest preceding exception instruction; and storing in a buffer, register renaming values relating to any registers whose data values are modified by said group of instructions and which are renamed by said register renaming logic as a bundle of register renaming values associated with said exception instruction.

A still further aspect of the present invention provides control means for storing values relating to unresolved exception instructions within a buffer storage means to enable a register renaming table within a processor to be restored following an exception; said processor being operable to process a stream of instructions from an instruction set, said instruction set comprising exception instructions and non-exception instructions, exception instructions being instructions that may generate an exception and non-exception instructions being instructions that execute in a statically determinable way, said processor comprising a physical set of registers operable to store data values being processed by said processor; and register renaming logic operable to map for each decoded instruction, registers from an architectural set of registers associated with said instruction set to registers within said physical set of registers in dependence upon renaming values stored in said register renaming table; said control means comprising a buffer storage means and being operable: to identify exception and non-exception instructions within a decoded instruction stream and to group any non-exception instructions with a closest preceding exception instruction; to store in said buffer storage means, register renaming values relating to any registers whose data values are modified by said group of instructions and which are renamed by said register renaming logic as a bundle of register renaming values associated with said exception instruction.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically shows a buffer for storing data relating to said unresolved exception instructions and an example instruction stream;

FIG. 2 schematically shows a data processing apparatus according to an embodiment of the present invention;

FIG. 3 schematically shows a portion of the data processing apparatus of FIG. 2;

FIG. 4 shows a flow diagram illustrating steps in a method according to and embodiment of the present invention; and

FIG. 5 a portion of the data processing apparatus of an embodiment of the present invention.

### DESCRIPTION OF THE PREFERRED EMBODIMENTS

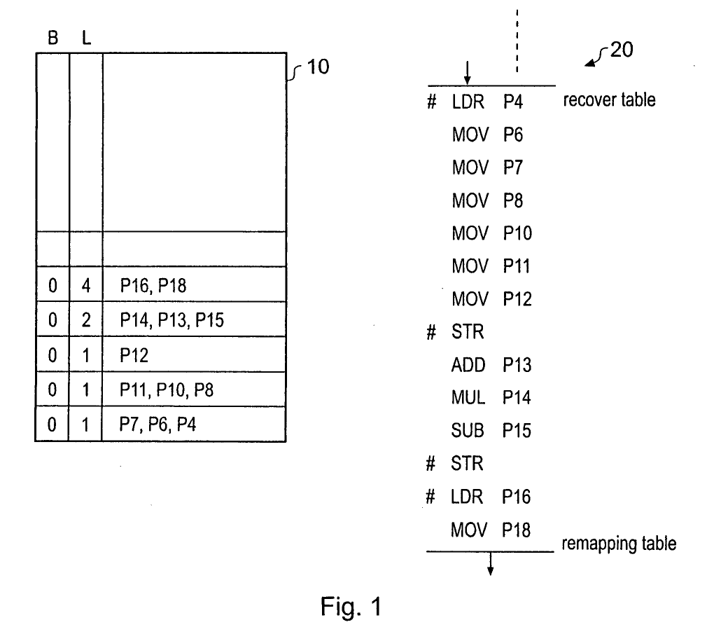

FIG. 1 shows a buffer 10 operable to store register renaming data that is needed to be able to restore a register renaming table if an exception occurs. FIG. 1 also shows an example stream of instructions 20, this stream of instructions was decoded in the direction of the arrow (that is the instruction at the top of the list LDR P4 was before MOV P6 in the instruction stream) and was then forwarded to register renaming logic, where the mapping between architectural registers and physical registers is performed, sequentially for each decoded instruction in the decoded instruction stream. The decoded instruction stream is shown as instructions with their remapped registers. Thus, P4, P6 etc. refer to physical registers present in the silicon, that the instruction shown write data values to. The portion of the instruction stream illustrated are the instructions that lie between the decoded instruction most recently remapped by the register remapping or renaming table and the decoded instruction whose remapping values are stored in the recover or restore table. The restore table is the table holding the values of the remapping table at the last resolved exception point. The last resolved exception point being an instruction in the instruction stream that can generate an exception but that a handling unit within the processing apparatus has determined will not do so. The instructions shown whose remapped registers are stored in buffer 10.

Thus, data relating to decoded instructions not yet remapped are not stored in buffer 10 and neither is data relating to decoded exception instructions that have been resolved.

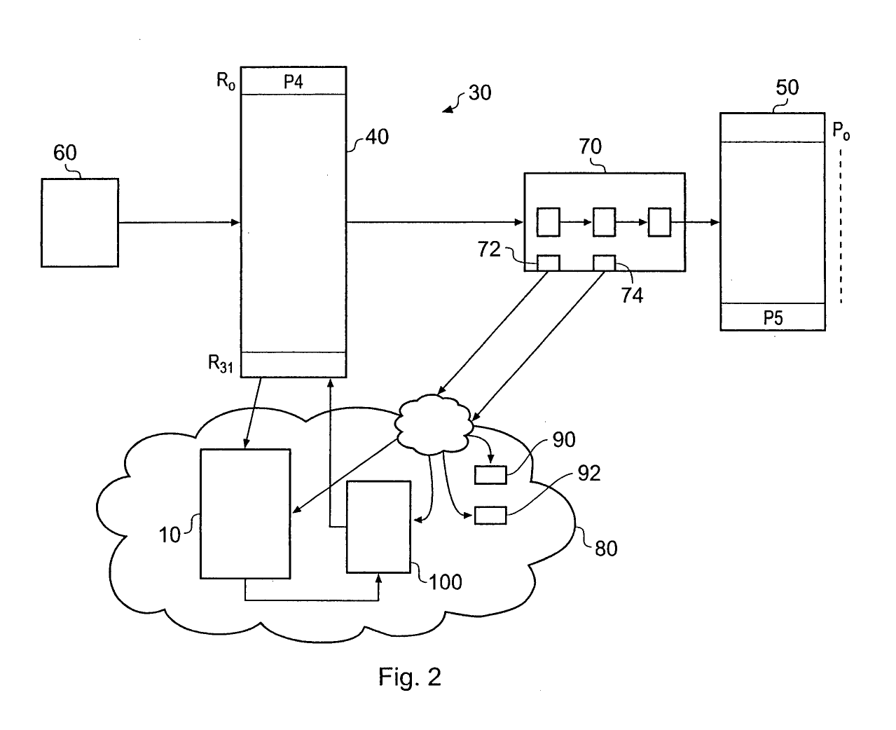

FIG. 2 shows a data processing apparatus 30 operable to process instructions such as the instruction stream 20 shown in FIG. 1. Data processing apparatus 30 comprises a renaming table 40 which is operable to store the mapping values which remap or rename registers from the architecture set which is how the registers are referred to in the instruction set to the physical set of registers 50 which are present in the silicon on data processing apparatus 30. An instruction stream is decoded by decoder 60 and the decoded instructions are sent to the renaming stage of the processor which is not shown in detail but which includes renaming table 40. Logic present on the data processing apparatus populates renaming table 40 with remapping values for the appropriate decoded instruction being received. Thus, if in the instruction being received register Rₒ in the architecture set is id be remapped to register P4 on the physical register set then the initial line of remapping table 40 contains the information P4. As the decoded instruction has not yet been executed by execution stage 70 this table is sometimes called a future table.

Control logic 80 is associated with renaming table 40 and is operable to control the storing of sufficient data to enable the renaming table 40 to be restored in the event of an exception occurring.

Thus, control logic 80 comprises buffer 10 and restore table 100. Restore table 100 contains tie values stored in the renaming table at the previous resolved exception. Thus, if an exception occurs the state of the processor can always be restored to the previous resolved exception instruction.

FIG. 1 shows how information from a decoded instruction that has been processed by renaming logic and had the renaming table populated for it is then stored in buffer 10. Control logic 80 of FIG. 2 detects decoded exception instructions, that is instructions that can generate an exception (these are marked by # in the instruction stream 20 of the figure) and groups these instructions with any subsequent decoded instruction that is not an exception instruction. Thus, looking at the instruction stream 20 in FIG. 1, from the oldest instruction shown, an exception instruction LDR is detected and the subsequent move instructions which are not exception instructions are grouped together with it. This group of instruction modifies the stored values in physical registers P4, P6, P7, P8, P10, P11 and P12 and thus information relating to these registers is stored in buffer 10. Although this is just shown in the figure as being the physical register itself, it is in effect the renaming or remapping that is stored in other words the architectural register and the physical register that it is remapped to is stored. Alongside these values are values marked as B or L in the figure. These provide an indication of the exception instruction that is being considered and this will be described in more detail later.

Looking again at FIG. 2, when a decoded exception instruction is detected by control logic 80, the type of exception that it might generate, is identified and the relevant counter 90 or 92 is incremented. In the embodiment shown there are two counters and these correspond to branch exceptions and memory access exceptions. Branch instructions can provide exceptions by being mispredicted, whereas memory access instructions can provide exceptions by the memory to be accessed not being accessible by the processor, for example it is secure memory for which that operation does not have sufficient privilege. There are of course other sorts of exception instructions that could be considered and more or fewer counters could be used.

In addition to the counters being incremented on detection of an exception instruction, the value identifying the instruction within buffer table 10 is also incremented. Thus, if a branch instruction is detected bit B is incremented, whereas if a memory access instruction is detected such as a load or store, bit denoted L is incremented.

Non-exception decoded instructions following an exception instruction are grouped together with the decoded exception instruction by the control logic 80 and all registers which store values that are modified are recorded in buffer 10 along with the instruction identifying information from the counter. Thus, if there are lots of registers that are renamed as is shown in FIG. 1 at the bottom of buffer 10 several lines are used with the same instruction identifier values.

In addition to receiving information about the decoded instruction stream being processed by the register renaming logic, control logic 80 also receives information from the execute unit 70 executing the decoded instruction stream and in particular from branch handling unit 72 or load store unit 74. These units can assess when a decoded exception instruction is resolved, i.e. when it is sure that it will execute. It may not at this point have actually executed, it is just that the unit has assessed that, for example the memory will be accessible or the condition code is correct. When this information is received by control logic 80, the appropriate counter 90, 92 is decremented as is the corresponding value in buffer table 10. This enables the buffer 10 to identify the next unresolved instruction by the numbers relating to it.

Furthermore, when the numbers B, L in buffer reach 00, this is an indication to the control logic that the exception instruction this data relates to has been resolved and that the restore table 100 can now be updated using the information stored in buffer 10. The advantage of this technique, is that information is stored relating to the registers rather than relating to individual instructions and it is only this information that is needed to update restore table 10Q. This is because the instructions that have been processed have only remapped the registers that are stored in this table and thus, the restore table only needs updating with this information. Furthermore, when an exception occurs the restore table is ready to be written to the remapping table to update it to the correct value in one clock cycle.

If an exception instruction does not write to a register, such that no remapping of a register is involved and if none of any immediately subsequent non-exception instructions write to a register, see for example the STR instruction above LDR P4 in the instruction stream 20, then the corresponding counter is incremented, in this case counter L, but no data is stored. This is because there is no information associated with this instruction that might be required to restore the remapping table following an exception. The counter needs to be incremented so that the logic can identify which instruction is resolved.

It should be noted, that although two counters are shown in this particular embodiment it is clear that only one counter could be used or that more counters could be used if there were more different types of exceptions. The advantage of using different counter values in this embodiment is that there are two exception instruction handling units 72 and 74 and these operate independently of each other. Thus, it may be that the condition of a branch instruction is found out to be correct before the memory accessibility of a load instruction which was received previous to the branch instruction. If these were not separate counters relating to these units then the counter would be decremented in response to the information, and it would be the load instruction that would appear at the bottom of the table when it had not yet been resolved.

It should also be noted that although the counters are shown as being incremented when an instruction is detected and decremented when it is resolved, this could clearly be done in the reverse sense, with the attainment of a predetermined value indicating that the buffer 10 should be flushed of the corresponding values.

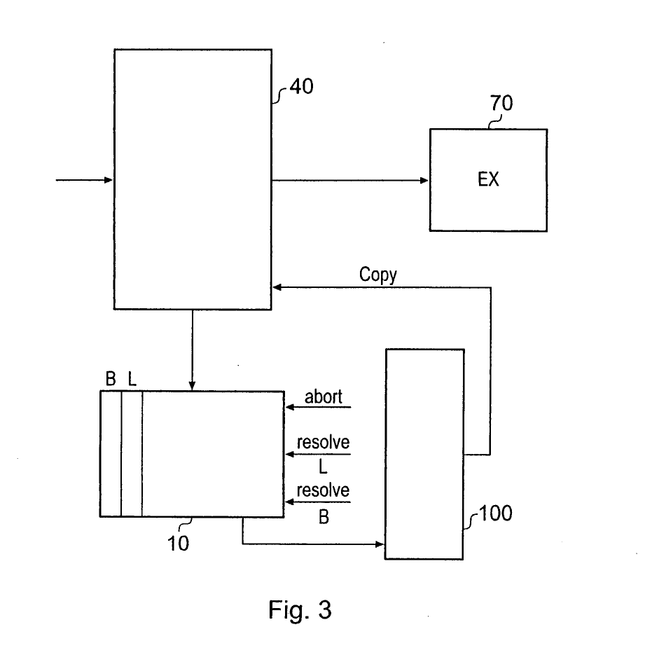

FIG. 3 shows schematically a portion of the data processing apparatus 30 shown in FIG. 2. In this figure, signals received at the buffer 10 from the execute unit 70 shown in FIG. I are shown in more detail. Thus, these signals include a signal indicating that a load/store instruction has been resolved, a signal indicating that a branch instruction has been resolved and an abort signal indicating that an exception has occurred.

In response to the abort signal, the contents of restore table 100 are copied to register renaming table 40. This restores the table to the value held at the previously resolved exception instruction. The PC is then forced to indicate the instruction to be processed following the abort.

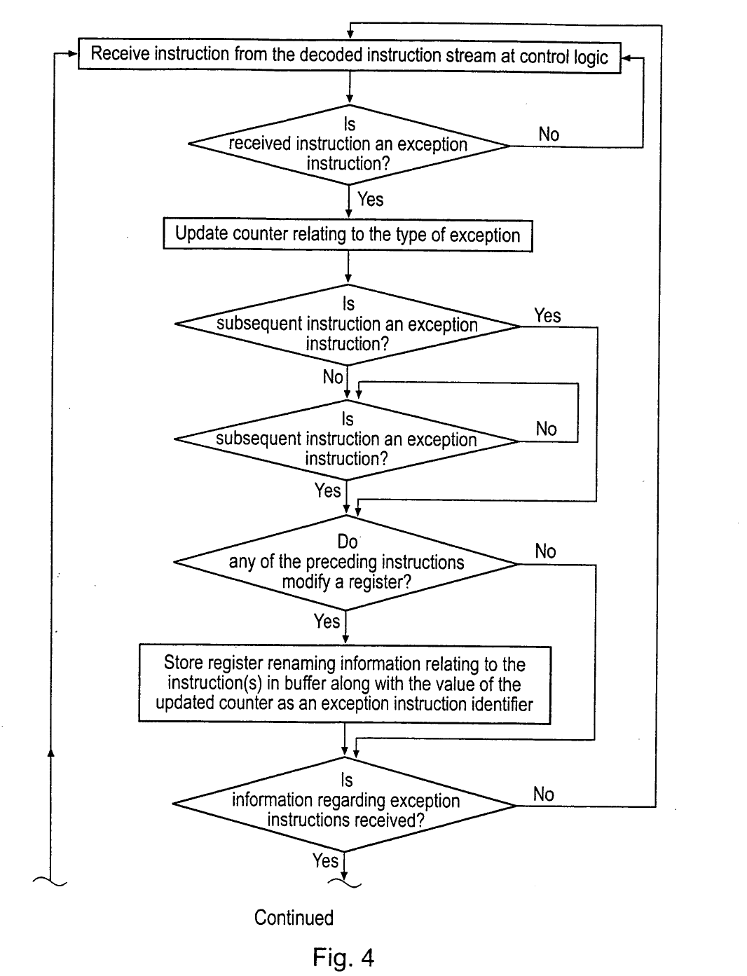

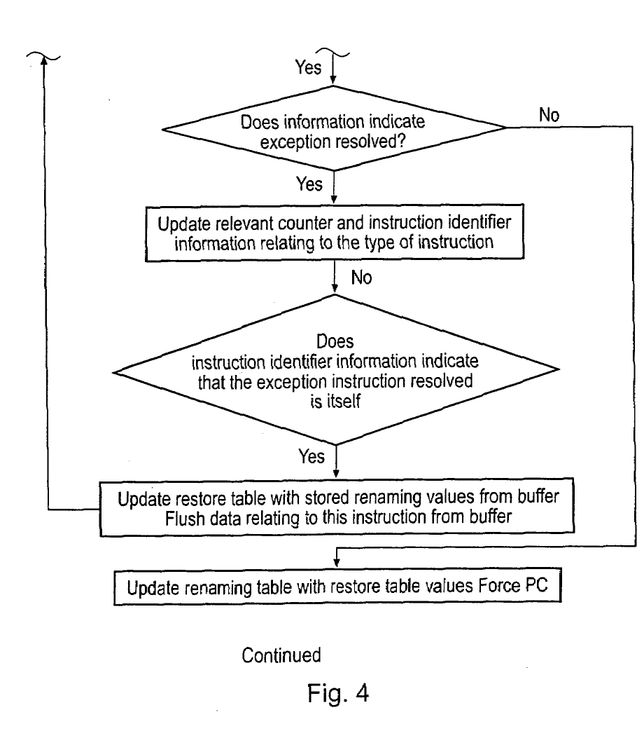

FIG. 4 shows a flow diagram showing a method according to an embodiment of the invention. In this embodiment the control logic receives an instruction from the decoded instruction stream and looks to see if the received instruction is an exception instruction. If it is not it looks at subsequent instructions until it detects an exception instruction. Once having detected an exception instruction it updates a counter (generally incremented) counting that type of exception instructions and then looks to see if the subsequent instructions are exception instruction.

When the subsequent instruction is not an exception instruction, control logic looks again until it finds an exception instruction. It then groups the first exception instruction together with any subsequently received non-exception instructions and then looks to see if any of this group of instructions modify a register. If any of them do it stores the renaming information relating to the modified registers in a buffer along with the value of the updated counter that acts to identify the exception instruction. If no registers are modified then no data is stored in the buffer.

The control logic also looks to see if information regarding decoded exception instructions previously remapped and being processed has been received. If there is no information then it returns to the top of the table to look at the next instruction from the decoded instruction stream to see if it is an exception instruction. If however information regarding exception instructions has been received it looks to see if this information indicates whether the exception is resolved or not. If it has been resolved it updates the relevant counter (generally by decrementing it) and the instruction identifier information within the buffer. It then looks to see if any of the instruction identifier information indicates that it is itself the exception instruction that has been resolved (generally the identifier value(s) are zero). If one of the instruction identifiers indicates that it has been resolved then the restore table is updated with the stored values from the buffer stored with that instruction identifier and then this information is flushed from the buffer. We then return to the top of the flow diagram and the next instruction from the instruction stream is examined to see if it is an exception instruction which of course it will be in this case.

If the information regarding an exception instruction received indicates that the exception has not been resolved and in fact an exception has occurred register renaming table is updated with the values from the restore table and the PC is forced to a value of the next instruction that is to be performed after the exception.

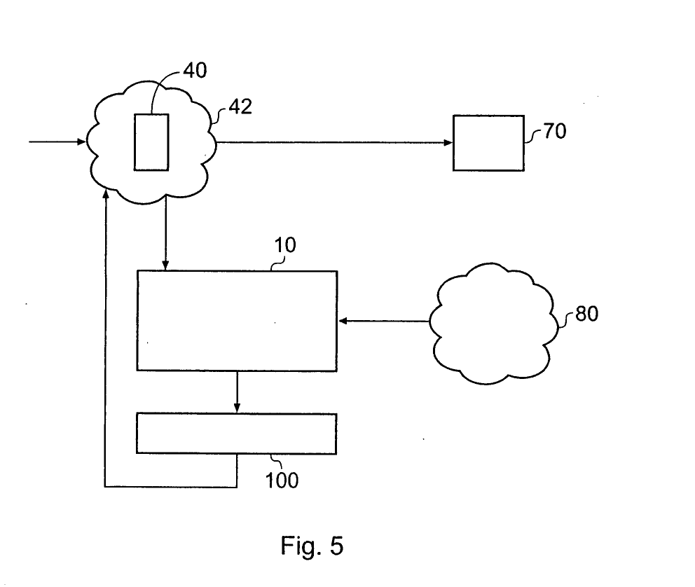

FIG. 5 schematically shows a portion of the data processing apparatus of an embodiment of the present invention. In this embodiment register remapping logic 42 is shown. This receives information signals from restore table 100. This can be following an exception in which case it updates table 40 with the information it receives. Alternatively, it may be following the resolution of an exception instruction when the restore table has been updated. In this case the physical register information from the stored remapping values that are to be overwritten are sent to register remapping logic 42, where they are entered into a ““free list” indicating which physical registers are free to be used in any remapping. One of the problems associated with renaming registers is to work out which physical registers will be free and therefore available for renaming once they have been allocated. A big advantage of the present technique is that this information is available “free” owing to the way the information is stored and treated. In effect, when a value is pushed out of the restore table then the physical register that has been pushed out is no longer used and can no longer be affected by an exception and as such can be allocated. There may be circumstances where condition codes are such that in fact this register is not actually available, however the renaming logic can work this out add not enter the physical register into the free list if this is the case. Thus, the information that this register is free from any exception circumstances is highly valuable and is a major advantage of the present technique.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. Control logic for storing values relating to unresolved exception instructions within a buffer to enable a register renaming table within a processor to be restored following an exception;
said processor being operable to process a stream of instructions from an instruction set, said instruction set comprising exception instructions and non-exception instructions, exception instructions being instructions that may generate an exception and non-exception instructions being instructions that execute in a statically determinable way, said processor comprising a physical set of registers operable to store data values being processed by said processor; and register renaming logic operable to receive a stream of decoded instructions and to map for each decoded instruction within said stream of decoded instructions, registers from an architectural set of registers associated with said instruction set to registers within said physical set of registers in dependence upon renaming values stored in said register renaming table;
said control logic comprising a buffer and being operable:
to identify exception and non-exception instructions within said decoded instruction stream and to group any non-exception instructions with a closest preceding exception instruction;
to store in said buffer, register renaming values relating to any registers whose data values are modified by said group of instructions and which are renamed by said register renaming logic as a bundle of register renaming values associated with said exception instruction.

2. Control logic according to claim 1, said control logic being further operable to receive information relating to said exception instructions and indicative of whether said exception instructions are resolved such that they are assured to execute and not generate an exception; and
in response to receiving information that an exception instruction is resolved to update a restore table within said processor with said register renaming values associated with said resolved exception instruction stored in said buffer; and
to flush said data associated with said resolved exception instruction from said buffer;
said restore table comprising renaming values for mapping registers from said architectural set to said physical set for a previously resolved exception instruction.

3. Control logic according to claim 1, wherein said buffer comprises a FIFO buffer.

4. Control logic according to claim 1, wherein said exception instructions comprise at least one of the following: memory access instructions and branch instructions.

5. Control logic according to claim 2, said control logic further comprising a counter, operable to count a number of exception instructions identified, said counter value being stored as instruction identifier data within said buffer along with said register renaming values associated with said identified exception instruction, said control logic being operable to amend said counter value and said instruction identifier data in response to receipt of information that an exception instruction is resolved, such that said counter value indicates a number of unresolved exception instructions identified.

6. Control logic according to claim 5, said control logic being operable to identify a group of instructions where no registers have data values that are modified by said group of instructions and no registers associated with said group of instructions are renamed by said register renaming logic, and to count said exception instruction from said group of instructions with said counter and not to store any data relating to said identified exception instruction in said buffer, said control logic being operable to amend said counter value in response to information that said identified exception instruction has been resolved.

7. Control logic according to claim 5, said control logic being operable in response to said instruction identifier data indicating no unresolved exception instructions before said exception instruction in said instruction stream to update said restore table with said register renaming values associated with said instruction identifier data and then to flush said associated register renaming values and said instruction identifier data from said buffer.

8. Control logic according to claim 5, said control logic being operable to store said register renaming values in a row in said buffer along with said instruction identifier data, and if said register renaming values will not fit in said row to store said remaining values in subsequent rows along with said instruction identifier data.

9. Control logic according to claim 2, wherein said control logic is operable when updating said restore table to retrieve any renaming values that are to be overwritten and to output data from said retrieved renaming values relating to the physical register renamed.

10. Control logic according to claim 4, said control logic being operable to identify said exception instructions as branch exception instructions and memory access exception instructions, said control logic comprising two counters, a branch counter operable to count a number of identified branch exception instruction, and a load counter operable to a number of identified memory access exception instructions, said values of said two counters being stored as instruction identifier data within said buffer along with said register renaming values relating to said identified exception instruction, said control logic being operable to amend said corresponding counter and said corresponding portion of said instruction identifier data in response to receipt of information that a branch or memory access exception instruction is resolved, such that said respective counter values indicate a number of unresolved exception instructions or a particular type identified.

11. Control logic according to claim 2, said control logic being operable in response to receiving information that an exception instruction has generated an exception, to flush said buffer and to forward said restore table to said processor for overwriting said register renaming table.

12. A data processing apparatus operable to process a stream of instructions from an instruction set, said instruction set comprising exception instructions and non-exception instructions, exception instructions being instructions that may generate an exception and non-exception instructions being instructions that execute in a statically determinable way, said processor comprising:
control logic according to claim 1;
an instruction decoder operable to receive and decode said stream of instructions;
a physical set of registers operable to store data values being processed by said data processing apparatus;
a data store operable to store a register renaming table comprising values that map each register of said architectural set to a register in said physical set for a decoded instruction;
register renaming logic operable to receive said stream of decoded instructions, and to populate said register renaming table with values appropriate for said received decoded instructions, said register renaming logic being operable to remap any registers associated with said received decoded instructions in dependence upon said values within said renaming table;
a further data store operable to store a recover table, said recover table comprising values from said remapping table for a previous instruction in said sequence of received decoded instructions, said previous instruction being a resolved exception instruction, a resolved exception instruction being an instruction that could have generated an exception but has been resolved not to.

13. A data processing apparatus according to claim 12, said data processing apparatus comprising at least one exception instruction handling unit operable to determine whether an exception instruction will generate an exception or whether it is resolved not to and operable to provide said information to said control logic

14. A data processing apparatus according to claim 13, said data processing apparatus comprising two exception instruction handling units one operable to handle decoded branch exception instructions and one operable to handle decoded memory access exception instructions, wherein said control logic is operable to identify said exception instructions as branch exception instructions and memory access exception instructions, said control logic comprising two counters, a branch counter operable to count a number of identified branch exception instruction, and a load counter operable to a number of identified memory access exception instructions, said values of said two counters being stored as instruction identifier data within said buffer along with said register renaming values relating to said identified exception instruction, said control logic being operable to amend said corresponding counter and said corresponding portion of said instruction identifier data in response to receipt of information from a corresponding exception instruction handling unit that a branch or memory access exception instruction is resolved, such that said respective counter values indicate a number of unresolved exception instructions or a particular type identified.

15. A data processing apparatus according to claim 13, said data processing apparatus comprising control logic, said control logic being operable in response to said instruction handling unit indicating said exception instruction will generate an exception to overwrite said register renaming table with said restore table and to flush said buffer, said data processing apparatus being operable to force said program counter.

16. A data processing apparatus according to claim 15, wherein said control logic is operable when updating said restore table to retrieve any renaming values that are to be overwritten and to output data relating to a physical register that has been overwritten to said register renaming logic, said register renaming logic being operable to determine a free list of physical registers available to be allocated from said received data.

17. A method for storing values relating to unresolved exception instructions within a buffer to enable a register renaming table within a processor to be restored following an exception, the processor being operable to process a stream of instructions from an instruction set, the instruction set comprising exception instructions and non-exception instructions, exception instructions being instructions that may generate an exception and non-exception instructions being instructions that execute in a statically determinable way, the processor comprising a physical set of registers operable to store data values being processed by the processor; and register renaming logic operable to map for each decoded instruction, registers from an architectural set of registers associated with the instruction set to registers within said physical set of registers in dependence upon renaming values stored in said register renaming table; said method comprising the following steps:
identifying exception and non-exception instructions within a decoded instruction stream;
grouping any non-exception instructions with a closest preceding exception instruction; and
storing in a buffer, register renaming values relating to any registers whose data values are modified by said group of instructions and which are renamed by said register renaming logic as a bundle of register renaming values associated with said exception instruction.

18. Control means for storing values relating to unresolved exception instructions within a buffer storage means to enable a register renaming table within a processor to be restored following an exception;
said processor being operable to process a stream of instructions from an instruction set, said instruction set comprising exception instructions and non-exception instructions, exception instructions being instructions that may generate an exception and non-exception instructions being instructions that execute in a statically determinable way, said processor comprising a physical set of registers operable to store data values being processed by said processor; and register renaming logic operable to map for each decoded instruction, registers from an architectural set of registers associated with said instruction set to registers within said physical set of registers in dependence upon renaming values stored in said register renaming table;
said control means comprising a buffer storage means and being operable:
to identify exception and non-exception instructions within a decoded instruction stream and to group any non-exception instructions with a closest preceding exception instruction;
to store in said buffer storage means, register renaming values relating to any registers whose data values are modified by said group of instructions and which are renamed by said register renaming logic as a bundle of register renaming values associated with said exception instruction.
